(19) United States
(12) Patent Application Publication
(10) Pub. No.: US 2018/0124155 A1
(43) Pub. Date: May 3, 2018

(54) NETWORK-BASED GROUP COMMUNICATION AND FILE SHARING SYSTEM

(71) Applicant: Microsoft Technology Licensing, LLC, Redmond, WA (US)

(72) Inventors: Dmitry A. Ryzhkov, Kirkland, WA (US); Neculai Blendea, Sammamish, WA (US); Kyle T. Blevens, Seattle, WA (US)

(21) Appl. No.: 15/455,848

(22) Filed: Mar. 10, 2017

Related U.S. Application Data
(60) Provisional application No. 62/415,903, filed on Nov. 1, 2016.

(51) Int. Cl. H04L 29/08; H04L 12/58

(52) U.S. Cl. CPC H04L 67/06; H04L 67/2804; H04L 51/16; H04L 51/04

(57) ABSTRACT

A system for sharing files over a collaborative communication environment has a user interface display that facilitates functionality in the collaborative communication environment. The collaborative communication environment has a chat interface for digital communication between first and second users. The system stores indications of the history of a chat between the first and second users, and an index of files shared in chats.

### CROSS-REFERENCE TO RELATED APPLICATION

The present application is based on and claims the benefit of U.S. provisional patent application Ser. No. 62/415,903, filed Nov. 1, 2016, the content of which is hereby incorporated by reference in its entirety.

### BACKGROUND

Many businesses have a workflow system in which individuals work in groups of two or more people. Group members may want to communicate with each other while not occupying the same office space. For example, team members may wish to communicate using an instant messaging (or online chat) platform. Additionally, team members often work together on shared files. Keeping track of current versions of shared files, in these types of scenarios, can be difficult. Additionally, determining which file a group member is discussing while using a chat service can be difficult.

The discussion above is merely provided for general background information and is not intended to be used as an aid in determining the scope of the claimed subject matter.

### SUMMARY

A system for sharing files over a collaborative communication environment has a user interface display that facilitates functionality in the collaborative communication environment. The collaborative communication environment has a chat interface for digital communication between first and second users. The system stores indications of the history of a chat between the first and second users, and an index of files shared in chats.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram showing a network-based communication system.

FIG. 2 shows a flow diagram for updating a file within the network-based communication system.

FIG. 3 shows a flow diagram for showing an index file list through a communication interface.

FIG. 4 shows a flow diagram for storing a shared file.

FIG. 5 shows a flow diagram for updating an file index.

FIG. 6 shows an example chat interface displayed by the network-based communication system.

FIGS. 7A and 7B show some example user interfaces displayed by the network-based communication system.

FIG. 8 is a block diagram showing a mobile device deployed in a cloud computing environment.

FIGS. 9-11 show examples of mobile devices.

FIG. 12 shows one example of a computing environment that can comprise, or be used with, a mobile device.

### DETAILED DESCRIPTION

Workplace projects are increasingly taking place in collaborative groups using cloud-based communication tools. One problem present with collaborative work involves sharing files between team members, and keeping track of shared files in the collaborative space. For example, a file shared between two or more users can be opened and edited by multiple users simultaneously. Additionally, when a later user indicates a desire to view or edit a shared file, it is important that the collaborative space retrieve the most up-to-date file version, and update an index and metadata associated with the file.

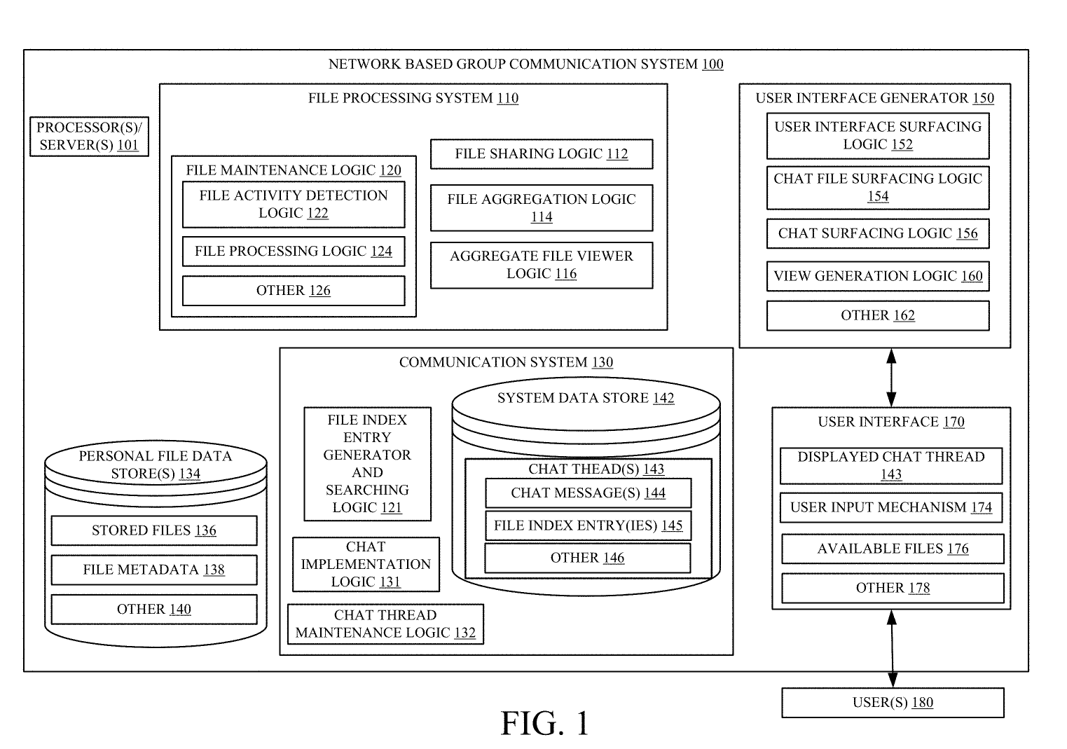

FIG. 1 is a block diagram of one example of a network-based communication system 100. A file collaboration experience can be integrated with system 100 with a group chat interface. This can be accomplished through file sharing functionality, combined with a shared file index, as is described below. Before describing the operation of system 100 in more detail, a brief overview of some of the items in system 100, and their operation, will first be provided.

Network-based communication system 100 can include one or more processors or servers 101, a file processing system 110, a communication system 130, one or more personal file data stores 134, a user interface generator 150, and a user interface 170 configured for interaction by one or more users 180. Communication system 130 can be configured to provide a chat experience between two or more users. Communication system 130 can include a system data store 142, file index entry generator and searching logic 121, chat implementation logic 131, and chat thread, maintenance logic 132. Chat implementation logic 131 illustratively provides functionality for users to engage in an online chat communication, which can include instance messaging, for instance. Chat thread maintenance logic 132 can be configured to maintain a chat identifier that uniquely identifies each chat thread 143, and update chat thread 143 with messages 144 as messages are entered by participants in the chat. It can also update a file index that has file index entities 145 (as the participants share files in the chat), and other information 146 associated with system data store 142.

For example, each chat experience, when initiated by a user, can be associated with a unique identifier, that also corresponds to a chat thread 143, such that it can be resumed by the users at a later time. Such identifiers can be stored in data store 142. System data store 142 can also include user log information, a user/chat index, a file/chat index, or any other information associated with a given chat between two or more users.

File index entry generator and searching logic 121 can be used to generate a file index entry 145 (and to search for such entries) when a user in a chat communication shares a file. File index entities 145 can include indications of what files were shared in a chat thread, who shared them, who they were shared with, what types of permissions were grated, when files were shared within the chat, the location of the files and corresponding file metadata, etc. For example, if a user shares a file, a visual indication of the shared file can be displayed within a user interface 170. Additionally, an index entry can be entered within the chat thread 143, for that chat, as well. The index entry 145 can be, in one example, entered such that a user is unaware of, or cannot see it. In another example, the index entry 145 is visible (or has a visible portion) to a user, separate from the indication of the shared file.

Network-based communication system 100 also includes a plurality of file data stores 134, each associated with a user of system 100, for example. Each file data store 134 can include stored files 136, associated file metadata 138, as well as other information 140. Data stores 134, in one example, are cloud-based stores. Data stores 134 can be individually accessible, by a file processing system 110 in response to a request to share a stored file 136.

File processing system 110 can include file sharing logic 112, file aggregation logic 114, aggregate file viewer logic 116, and file maintenance logic 120. File maintenance logic 120 can, itself, include file activity detection logic 122, file processing logic 124, and other logic 126. File accessing logic 122 is configured to communicate with, and access, communication system 130 and personal file data store 134. File sharing logic 117 is configured to, in response to a received request to share a stored file 136, provide the location of the shared file, and update file metadata 138 with an indication of the updated access permissions (e.g. that the user with whom the file was shared has read and/or write access to the shared file).

File aggregation logic 114 is configured to retrieve, and aggregate one or more files upon receiving a user request to share or access the one or more files. Aggregate file viewer logic 116 is configured to provide files for surfacing by a user interface generator 150, to present on user interface 170. For example, an aggregate view of files that can be shared by the user may be generated with a user actuatable element corresponding to each file. The user can select and share a file by actuating one of the user actuatable elements.

File maintenance logic 120 is configured to interact with specific files retrieved from file data store 134 or other stores. For example, file activity detection logic 122 is configured to detect changes made to a given file, (such as when a user edits information, deletes information, saves information, adds information, creates a new file, renames an existing file, etc.) Additionally, file maintenance logic 120 can include file processing logic 124 which is configured to process changes made to a file by a user 180 and detected by file activity detection logic 122. File maintenance logic 120 can also include other functionality 126. Changes to a shared file can be stored as part of stored file 136, in one example, and file metadata 138 can be updated accordingly.

User interface generator 150 can include user interface surfacing logic 152, chat file surfacing logic 154, chat surfacing logic 156, view generation logic 160, and other functionality 162. User interface generator 150 can be used to generate one or more user interfaces 170 for interaction by user 180.

As mentioned above, user interface 170 can include a representation of a chat thread 143, a user input mechanism 174, in some cases a display of available files 176, and other items 178. A user 180 interacts with network-based communication system 100 using user interface 170. Logic 152 and other logic in generator 150 can detect user interactions with user input mechanisms on interface 170. A displayed chat thread 143, comprising for example, previous messages with a given user, visible on user interface 170, can be generated using chat surfacing logic 156. As mentioned above, chat thread 143 can also include indications of shared files exchanged within a given chat and shared file index entries, which can be visible or hidden from a user 180 who is viewing chat thread 143 on user interface 170. User 180 can also see an indication of available files 176, such as when a user is selecting a file to share. The displayed chat thread 143 can have user input mechanisms 174 for user interaction as well.

When user 180 interacts with chat thread 143, for example using user input mechanism 174, such as by typing and sending a new message, user interface generator 150 can use chat surfacing logic 156 to update a viewable current communication on chat thread 143, displayed on user interface 170. Chat file surfacing logic 154 can be used, for example, when a user has indicated that he or she wishes to view a shared file in displayed chat thread 143. User interface generator 150 can also comprise other functionality 162 which can provide other indicia 178 on the user interface. For example, a user 180 can interact with one or more actuatable elements that provide the option to upload a file that is not saved currently in a personal file data store 134. Additionally, a user can download a shared file to a local store, among a wide variety of other things.

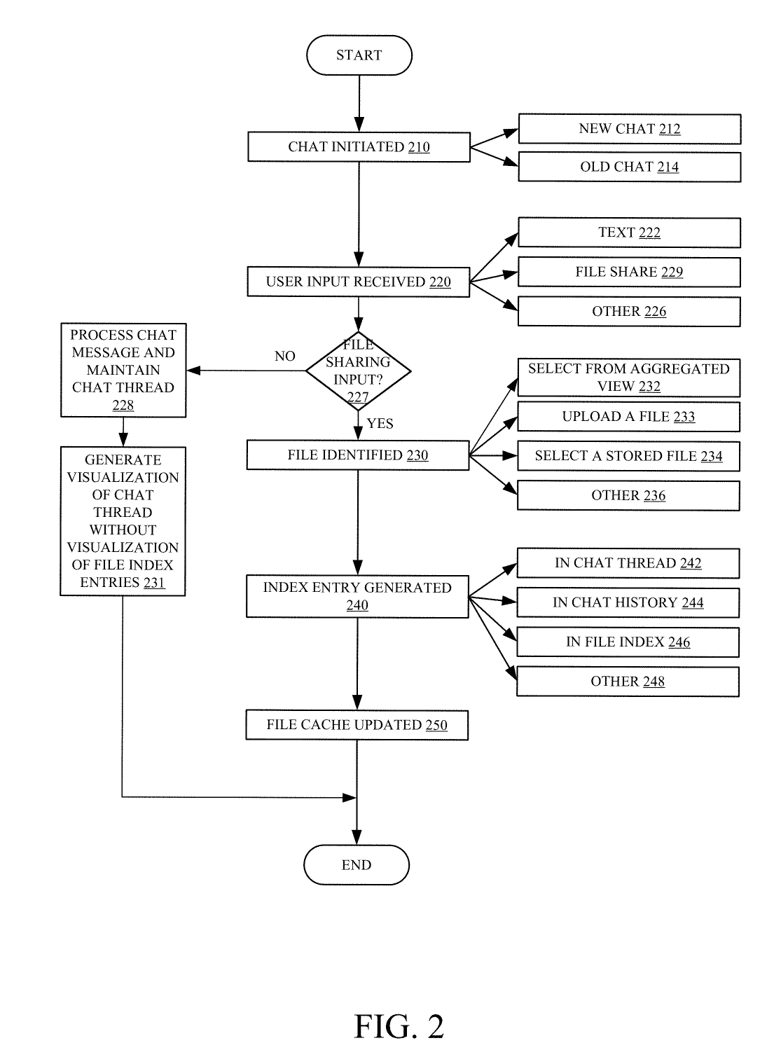

FIG. 2 shows a flow diagram, illustrating one example of the operation of system 100 in sharing and/or updating a file within the network-based communication system 100. At block 210, a chat is initiated. The chat can be initiated by chat implementation logic 131 as a new conversation stream between two or more users, as indicated in block 212, or resumption of a chat between two or more users who have previously communicated, as indicated in block 214. For example, using chat thread maintenance logic 132, a chat thread 143 can be retrieved from data store 142. It will be noted that while chatting and file sharing is described herein with respect to two users for the sake of simplicity, it is to be understood that a chat can have more than two users, for example, 3, 4, or an even greater number of users communicating through a shared communication portal.

In block 220, a user input is received, for example from a user 180 using a user input mechanism 174 on a user interface 170. The user input can comprise new text, as indicated in block 222, which may represent a new communication or message within the chat. The user input can also comprise a user indicating a desired file to share, for example as indicated in block 224. The user input can also comprise one or more other inputs, as indicated in block 226. For example, other inputs can include one of the users typing a response.

In response to the received user input, chat surfacing logic 156 is configured to update displayed chat thread 143 to indicate the received user input. For example, updating displayed chat thread 143 can include providing an indication of a new text input, or an indication of a shared file, or another indication.

User interface generator 150 then determines whether the detected user input is a file sharing input indicating that the user wishes to share a file. This is indicated by block 227. If not, then the user input is processed as a chat message input and the chat history and corresponding chat thread 143 are updated. This is indicated by block 228. Chat surfacing logic 156 generates a view of the updated thread 143 or history, without showing any file index entries. This is indicated by block 231.

If, at block 227, the user input is identified as one for sharing a file, then at block 230, the desired file is identified. This can be done, for example, by having file aggregation logic 114 aggregate different files that are sharable by the user and having aggregate file viewer logic 116 generate a view with a user actuatable element corresponding to each file. The user can actuate one of the elements to share the corresponding file. This is indicated by block 232.

Identifying the file can also be done by identifying that a user 180 has interacted with a user input mechanism 174 to upload a file to be shared, as indicated in block 233. This can be detected, for example, using file aggregation logic 114. Additionally, identifying a file can also include identifying that a user has shared a stored file 136, as indicated in block 234. However, a file can also be identified as coming from another source, as indicated in block 236.

At block 240, file index entry generator logic 121 generates a file index entry 145. For example, thread 143 can be updated to show that a second user has now been given access to the shared file. The index entry 145 can also indicate that the shared file is associated with a unique chat identifier. The index entry 145 can be generated within the chat thread itself, as indicated in block 242, such that it is visible to a user. However, in another example, the index entry 145 is stored only in the chat history or chat thread such that it is not visible to the users participating in the chat, as indicated in block 244. In another example, the index entry 145 is stored in a cached file index, as indicated in block 246. Other configurations are also possible, as indicated by block 248.

At block 250, the shared file can be updated by file sharing logic 112. Updating a file can include updating file metadata 138 with access permissions granted as part of the sharing operation. Updating a file can also include updating file data store 134 such that a newest version of the file is stored in stored files 136, for example in response to edits made by a second user. It will be noted that file maintenance logic 120, file activity detection logic 122 and file processing logic 124 can be configured to detect and implement edits by either the sharing user or the receiving user, with appropriate permissions.

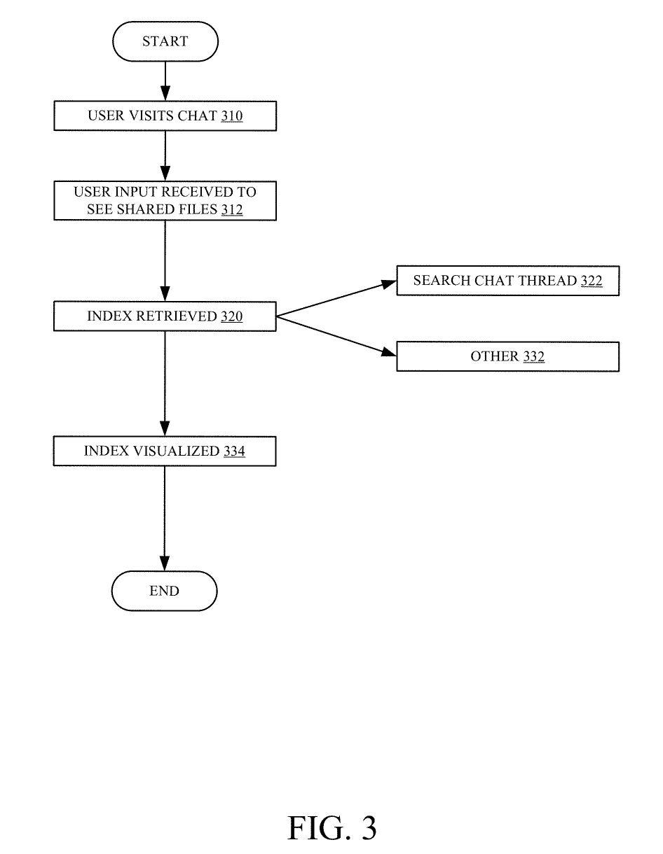

FIG. 3 shows a flow diagram illustrating one example of the operation 300 of system 100 in showing a file index representation list through a communication interface. The operation 300 can be used, for example, to provide a user with an indexed list of available files that were accessed or shared in a chat thread.

At block 310, a user actuates a user input mechanism 174 to enter or initiate a chat. For example, a user 180 can indicate a desire to resume a chat currently existing in a chat thread 143. In another example, user 180 can create a new chat with another user.

Chat file surfacing logic 154 then detects that the user has actuated a user input mechanism to see a list of files shared in the chat. This is indicated by block 312. At block 320, an index of shared files, shared within the chat, is retrieved. For example, file index searching logic 121 can search a chat thread 143 or chat history 172 for file index entries. This is indicated by blocks 322. It can do this by searching for file index entries generated and stored in line with other chat messages, to identify files previously shared and access rights granted. In one example, the file index entries are specifically marked to distinguish them from other entries in chat thread 143, so they can easily be located by searching logic 121. The search can be done in other ways as well, as indicated by block 332.

At block 334, an index visualization is generated, for example, by chat file surfacing logic 154. The visualization can represent a list of, or other representation of, files that were accessed or shared within the chat, based on the file index entries located in the chat thread 143 that was searched.

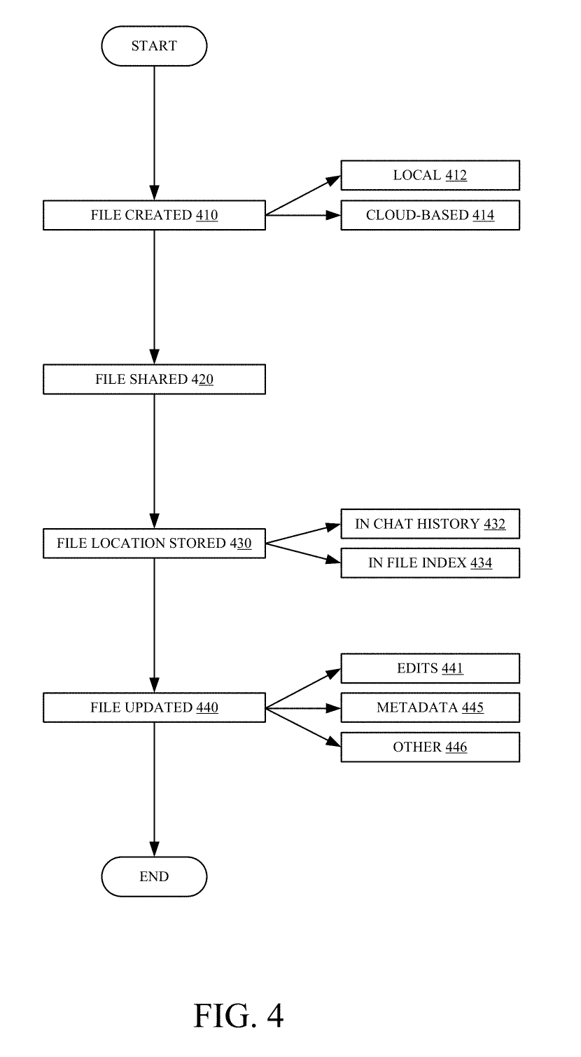

FIG. 4 shows a flow diagram illustrating one example of the operation 400 of system 100 in storing a shared file within network based group communication system 100. Network-based group communication system 100, in addition to allowing existing files to be shared across a communication platform, can also be used to generate, store and share new files, as indicated in operation 400.

At block 410, a new file is created, for example, by user 180 using interface 170. The newly created file can be stored locally, as indicated in block 412, or stored within personal file data store 134, as one of stored files 136. Initially, a newly created file is not associated with any specific chat thread 143, and may only be associated with a single user (such as its author) or otherwise. In another example, the file can be created and stored within a cloud-based or other environment, as indicated by block 414.

At block 420, the file is shared, for example using a user input mechanism 174 on user interface 170. Chat surfacing logic 156 can provide an indication within a chat thread that a file has been shared between one user within the chat and another user within the chat or, for example, with a whole group within a group chat. As discussed above, sharing a file can include providing editing rights, or read only rights, for instance. Once shared, file sharing logic 112 can update metadata 138 to indicate the change in permissions granted. Index entry generator logic 121 can also, after a file is shared, update chat thread 143, with a file index entry indicating where the file is presently stored, the new permissions and which unique chat is associated with the sharing activity, among other things. Additionally, upon being shared, file maintenance logic 120 can allow for other users to actively engage with the file using, for example, file activity detection logic 122 which detects user engagement with the file (for example editing, saving, deleting, etc.). File processing logic 124 can implement detected interactions or file changes.

At block 430, a file location is stored (and may also be cached). It will be noted that combining personal file data storage, such as data store 134, with a system-stored index provides the ability to have different files, with the same names, to be recognized by the system without causing conflict. In one example, the file location is cached as part of an index entry within the chat, such that it is searchable by file aggregation logic 114. For example, an in-line index entry (in-line with other messages in the chat) as indicated in block 432, can store an indication of where a shared file is stored (for example, within personal file data store 134), when it was shared, what new access rights were granted, and to which user(s), etc. In another example, the file location is cached as part of a cached file index, as indicated in block 434.

In block 440, a file is updated, for example using file maintenance logic 120. Updating a file can include updating file data store 134 such that a newest version of the file is stored in stored files 136, as a reflection of edits made by either the sharing or receiving user. This is indicated in block 442. For example, file maintenance logic 120, file activity detection logic 122 and file processing logic 124 can detect and implement edits by either the sharing user or the receiving user. Updating a file can include updating file metadata 138, as indicated in block 444. Additionally, other information, for example other information 140, can also be updated, as indicated by block 446.

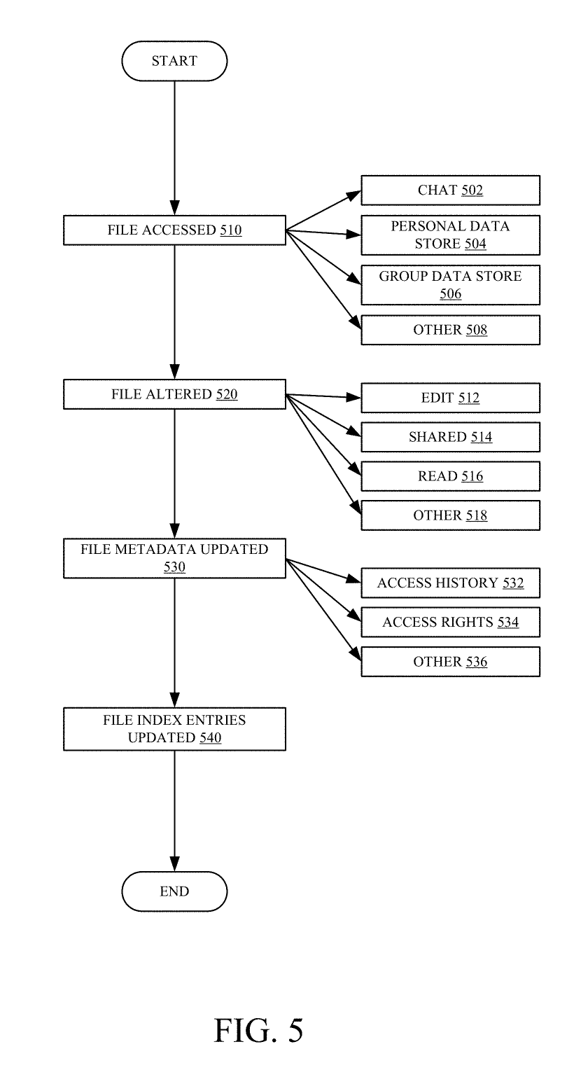

FIG. 5 shows a flow diagram illustrating one example of the operation 500 of system 100 in updating a file index. This can help to ensure that, when a user 180 accesses a file, for example shared from another user, that a desired version (e.g., the most current version) of the file is accessed.

At block 510, a file is accessed. For example, a file can be shared by one user with another user through a chat interface, as indicated in block 502. The file can also be shared from a personal data store 134, as indicated in block 504. Additionally, the file can be shared from system data store 142, or a cloud-based data store, as indicated in block 506. Other sources of files are also possible, as indicated in block 508. The receiving user may wish to access the file, once shared. Additionally, the sharing user may also wish to access the file, or the sharing user may be concurrently accessing the file.

At block 520, the shared file is altered. For example, either the sharing or receiving user can make edits to the shared file, as indicated by block 512. Additionally, altering the file can include altering the permissions for the file, such as, altering which users have access or editing rights. In another example, altering the shared file can include indicating that a user has read the file, as indicated in block 546. Indexing and storing information about when a file was last accessed/edited can be helpful when file aggregation logic 114 and user interface generator 150 present aggregated files to a requesting user based on that information, such as when the files are presented in an order, sorted by recency of access, etc. Other alteration operations can also be stored, as indicated in block 518.

At block 530, file metadata 138 is updated. For example, an access history associated with the file (and stored as file metadata 138) can be updated, and stored in data store 134, as indicated in block 532. Additionally, access right information can be updated, to reflect that a new user has access/edit rights, as indicated in block 534. Additionally, other file-associated metadata can also be updated, as indicated in block 536.

At block 540, a file index entry can be updated. For example, if altering the file comprises storing the file in a new location, a new indication of the file location can be stored within the system.

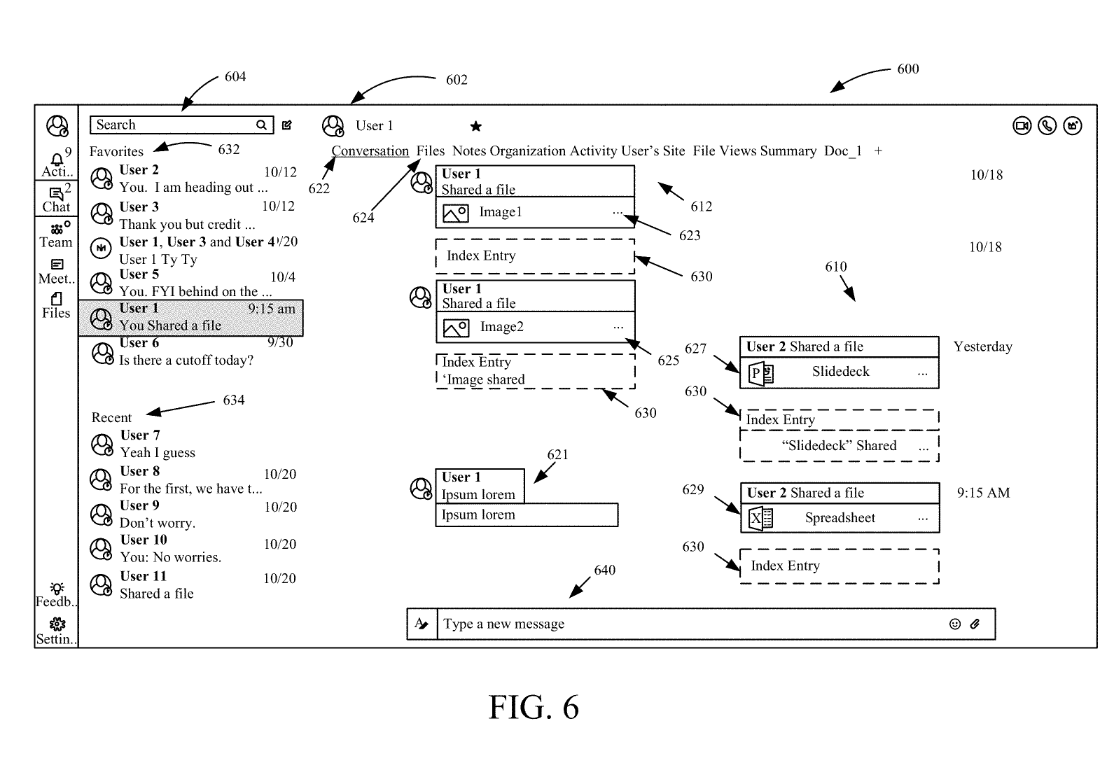

FIG. 6 shows an example chat interface 600 that can be displayed by the network-based communication system to a user of network-based communication system 100. The user illustratively has one or more ongoing chats shown in chats pane 604 (each with its own user actuatable element and corresponding chat thread 143), that can be sorted based on user preference (e.g. favorites 632 or recent chats 634 as indicated in FIG. 6). The chat interface 600 can include, for example, a user space 602 configured to allow a user to access different functionality. For example, as shown in FIG. 6, a conversation tab 622 is shown. When tab 622 is actuated, display 600 illustrates a conversation between the user (labeled User 1) and another individual (labeled User 2). The items in thread 143 that were generated by User 1 are shown generally at 612, while those generated by another user (User 2) are shown generally at 610.

As illustrated in FIG. 6, in some examples, the items in the thread are text messages 621 generated by typing into message box 640 and hitting the enter key. In other examples, they are user actuatable indications of a shared file (623, 625, 627 and 629) provided within the chat interface as part of the conversation stream when the file is shared. A user with whom the file is shared can, for example, access (e.g., open and take action on) the file by actuating the provided indication 623, 625, 627 and 629.

In one example, an index entry 630 is also added to the chat thread when a file is shared. As represented in FIG. 6, in some examples, the index entry 630 is hidden from users, such that users only see an indication (623, 625, 627 and 629) of the shared file and other textual chat messages 621. However, in other examples, the index entry is visible to the users in the chat. While the file index entries are all labeled 630 in FIG. 6, it will be appreciated that they will differ to identify the shared file when it was shared, with whom, the permissions granted, etc.

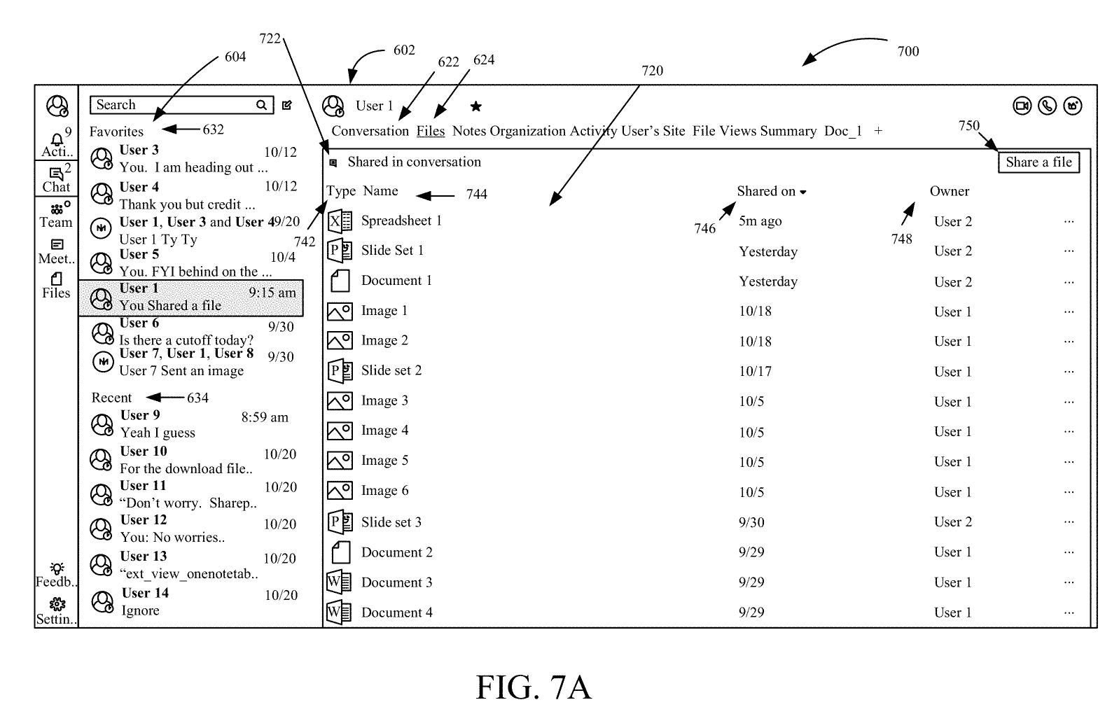

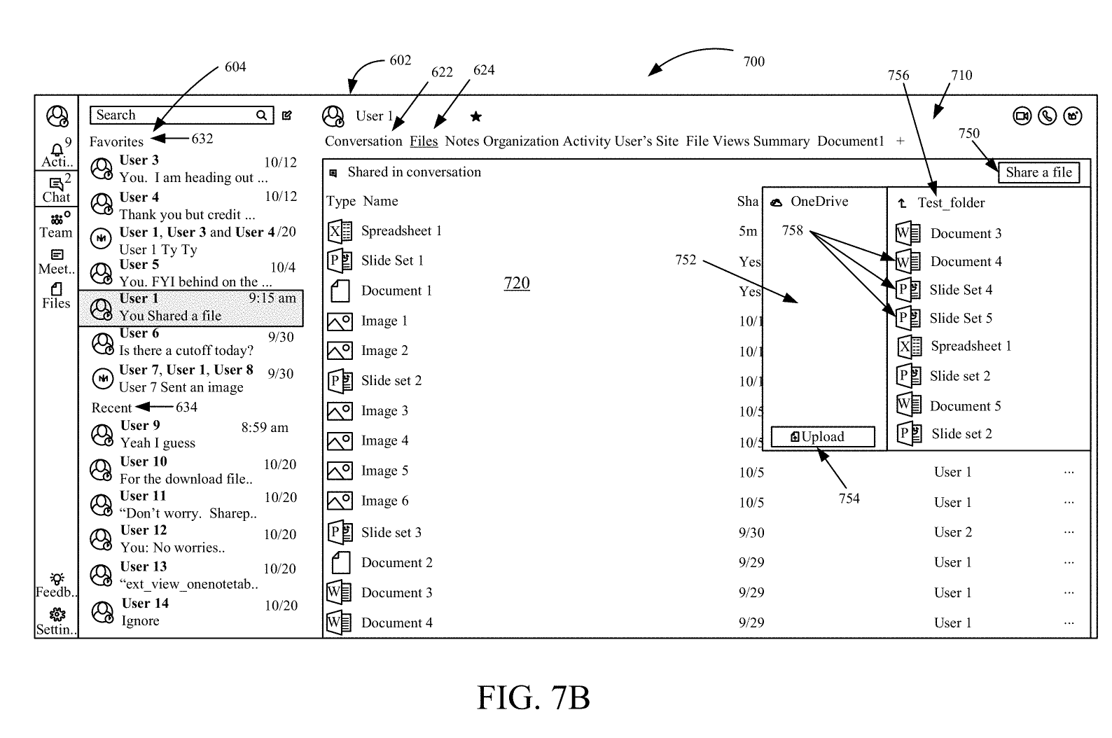

FIG. 6 also shows that, in one example, interface 600 also includes a Files tab 624. This can be actuated by the user to see a list of shared files, that were shared within the selected chat thread 143 being displayed. This is described in more detail with respect to FIGS. 7A and 7B.

FIGS. 7A and 7B show some example user interfaces that can be displayed by the network-based group communication system 100. Some items in these FIGS. Are similar to those shown in FIG. 6 and are similarly numbered. FIG. 7A illustrates user interface 700 has a files tab 624. The user can actuate tab 624 to see shared files, that were shared in the currently-selected chat thread. A file portion 720, illustratively presents a list of files shared by, or with, User 1. For example, each shared file has a file type 742, a file name 744, a date shared 746, and a file owner 748. File owner 748 can be User 1, or an individual who has shared a file with User 1. The list of shared files can be generated by logic 121 searching for file index entries 630 in a chat thread 143 corresponding to a chat conversation selected by the user in pane 604. When the user actuates the files actuator 624, logic 121 (in FIG. 1) can perform the search and the list can be generated and surfaced for user interaction, based on the returned search results.

If a user wants to share a new file, the user can select the “share a file” actuator 750. FIG. 7B shows that, in response, file sharing portion 752 is displayed, illustrating a selected folder 756, with files 758 available to be shared. For example, User 1 can share files stored in their personal data store 134. However, User 1 can also share a locally-stored file, using upload actuator 754 to upload the file from a selected location. Sharing a locally stored file using upload actuator 754 can, for example, causes system 100 to add a copy of the file to stored files 136, and update metadata 138 accordingly.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

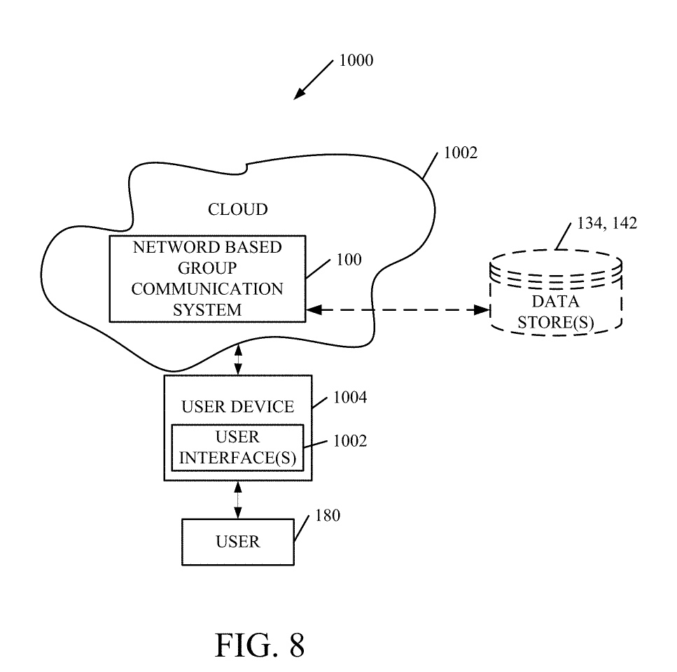

FIG. 8 is a block diagram of architecture 1000, shown in FIG. 1, except that its elements are disposed in a cloud computing architecture 1002. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component.

Software or components of architecture 1000 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud is managed by the organization itself and the infrastructure is typically not shared with other organizations. The organization still maintains the hardware to some extent, such as installations and repairs, etc.

In the example shown in FIG. 8, some items are similar to those shown in FIG. 1 and they are similarly numbered. FIG. 8 specifically shows that network based communication system 100 can be located in cloud 1002 (which can be public, private, or a combination where portions are public while others are private). Therefore, user 180 uses a user device 1004 to access those systems through cloud 1002.

FIG. 8 also depicts another example of a cloud architecture. FIG. 8 shows that it is also contemplated that some elements of system 100 can be disposed in cloud 1002 while others are not. By way of example, data stores 134 and 142 can be disposed outside of cloud 1002, and accessed through cloud 1002. Regardless of where they are located, they can be accessed directly by device 1004, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

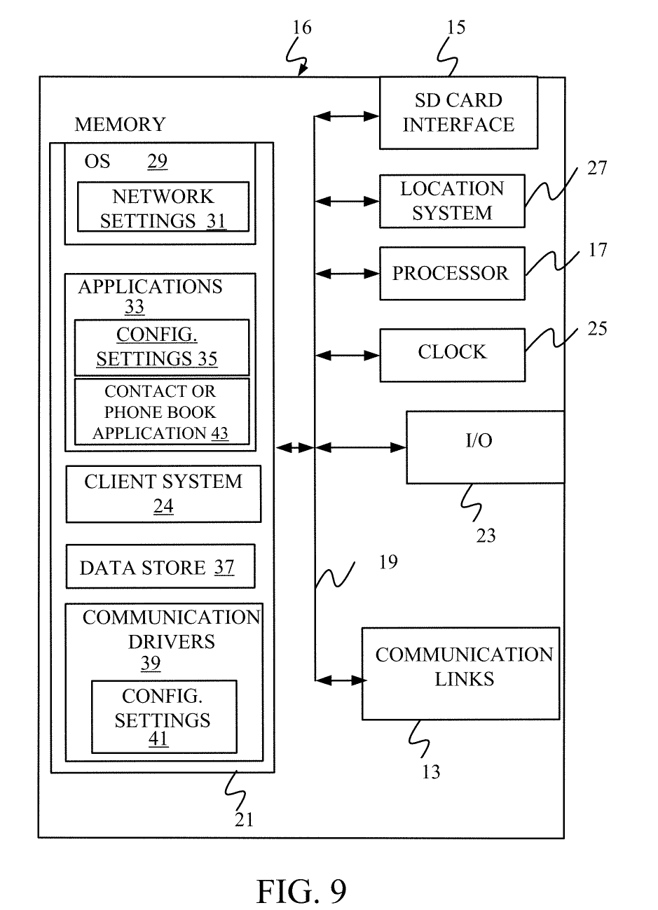

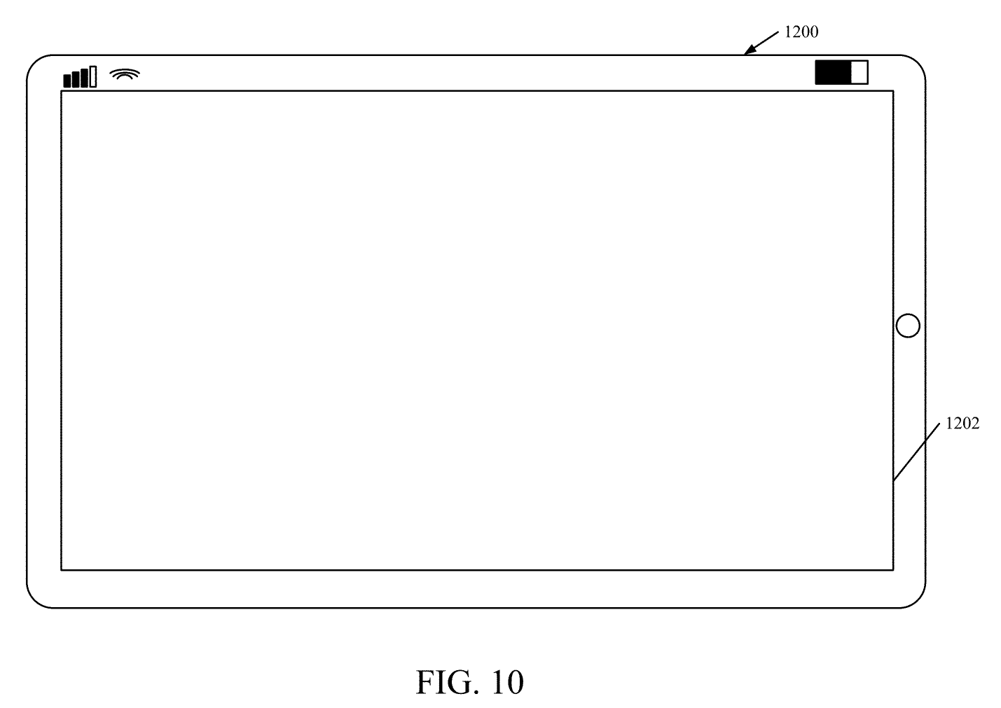

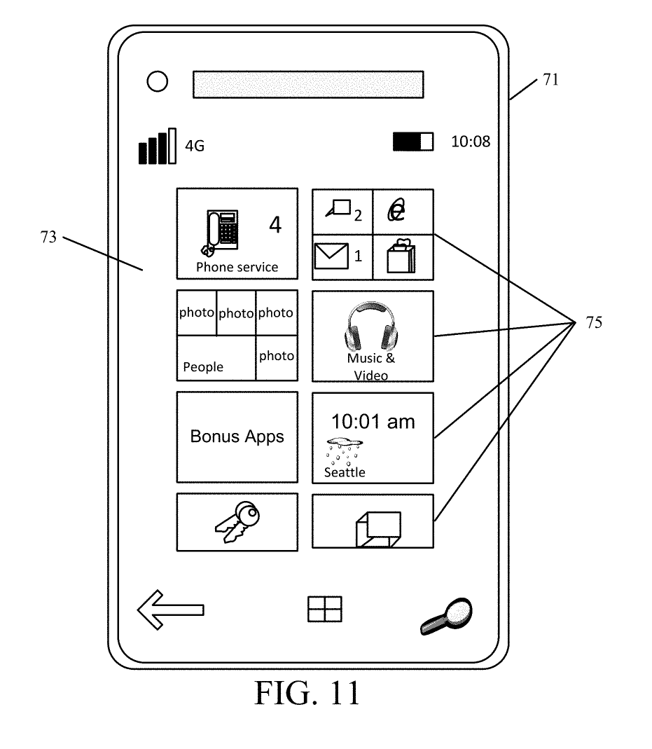

FIG. 9 is a simplified block diagram of one illustrative example of a handheld or mobile computing device that can be used as a user's or client's hand held device 16, in which the present system (or parts of it) can be deployed. FIGS. 10-11 are examples of handheld or mobile devices.

FIG. 9 provides a general block diagram of the components of a client device 16 that can run components of data stores 134, 142, communication system 130, file processing system 110 and/or network-based group communication system 100 or that interacts with those items, or both. In the device 16, a communications link 13 is provided that allows the handheld device to communicate with other computing devices and in some examples provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can be configured to facilitate any of logic 112, 114, 116, 118, 120, 122, 124, 121, 132, 152, 154, 156, 158, and/or 160) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. File processing system 110, communication system 130 and/or the items in data stores 134, 142 for example, can reside in memory 21. Similarly, device 16 can have a client system 24. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 shows one example in which device 16 is a tablet computer 1200. Screen 1202 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 1200 can also illustratively receive voice inputs as well.

FIG. 11 is similar to FIG. 10 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

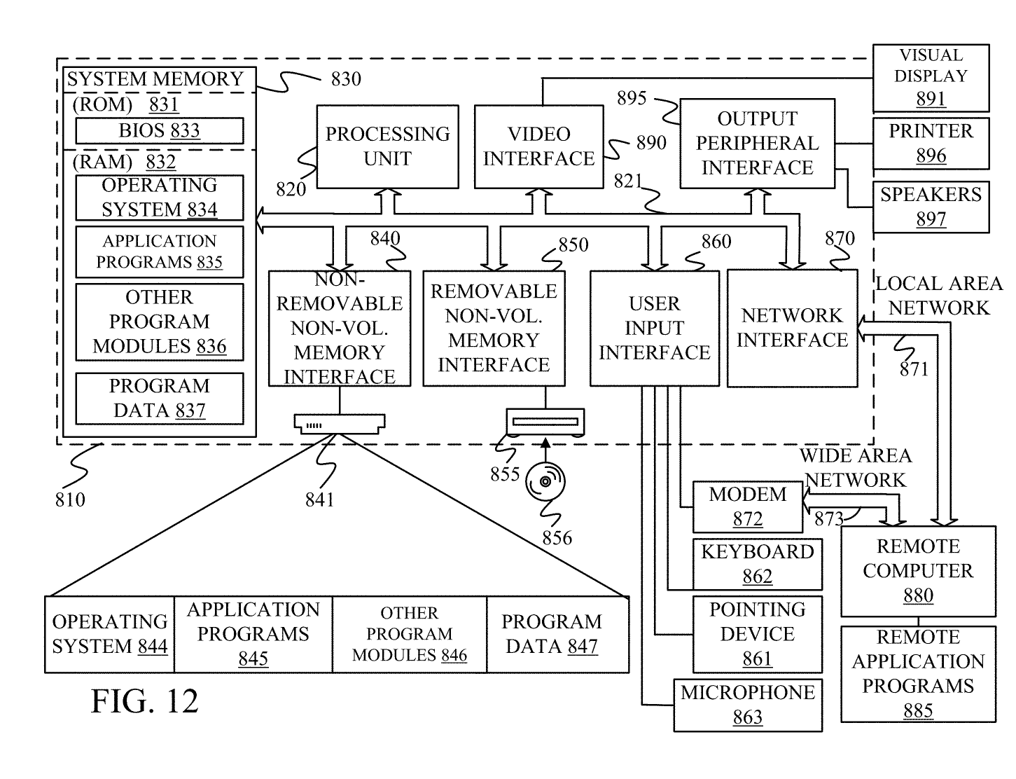

FIG. 12 is one example of a computing environment in which architecture 100, or parts of it, (for example) can be deployed. With reference to FIG. 12, an example system for implementing some embodiments includes a general-purpose computing device in the form of a computer 810. Components of computer 810 include, but are not limited to, a processing unit 820, a system memory 830, and a system bus 821 that couples various system components including the system memory to the processing unit 820. The system bus 821 can be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a communication system that facilitates a chat communication between a first user and a second user by sending messages between the first user and the second user based on chat user inputs from the first and second users user through a chat user interface, the communication system generating a file sharing input to file sharing logic based on a file sharing user input from the first user through the chat user interface, the file sharing input identifying a file to be shared with the second user through the communication system;

maintenance logic that maintains a chat thread indicative of messages sent between the first and second users in the chat communication;

file index entry generator logic that generates a file index entry in the chat thread, the file index entry identifying the file to be shared and metadata indicative of the file sharing input; and

file index searching logic that searches the chat thread for the file index entry and generates a file index representation indicative of any file index entries identified by the search.

Example 2 is the computing system of any or all previous examples and further comprising:

chat file surfacing logic configured to generate a visualization of the file index representation for user interaction.

Example 3 is the computing system of any or all previous examples wherein the file index generator logic is configured to generate the file index entry so that it is searchable separately from other messages in the chat thread, sent between the first and second users.

Example 4 is the computing system of any or all previous examples and further comprising:

chat surfacing logic configured to surface the chat thread for user visualization, without surfacing the file index entry in the chat thread, for user visualization.

Example 5 is the computing system of any or all previous examples wherein the chat file surfacing logic is configured to receive a user search input indicative of a search request, and wherein the file index searching logic is configured to identify any files shared in the chat and to search for any file index entries in the chat thread based on the user search input.

Example 6 is the computing system of any or all previous examples wherein the file sharing logic is configured to modify file access permissions based on the file sharing input.

Example 7 is the computing system of any or all previous examples and further comprising:

user interface logic configured to receive a user file sharing request input indicative of a request to share a file through the communication system.

Example 8 is the computing system of any or all previous examples and further comprising:

file aggregation logic that aggregates file identifiers indicative of shareable files, based on the file sharing request input; and

aggregate file viewer logic configured to generate an aggregate file view with a user actuatable element corresponding to each shareable file, the file sharing logic being configured to modify file access permissions for a given file, based on user actuation of a user actuatable element.

Example 9 is a computer implemented method, comprising:

receiving chat user inputs from a first user and a second user through a set of chat user interfaces;

sending messages between the first user and the second user in a chat communication based on the chat user inputs from the first and second users through the chat user interface;

receiving a file sharing user input from the first user through the chat user interface;

generating a file sharing input to file sharing logic based on the file sharing user input from the first user through the chat user interface, the file sharing input identifying a file to be shared with the second user through the communication system;

generating a chat thread indicative of the messages sent between the first and second users in the chat communication; and

generating a file index entry in the chat thread, the file index entry identifying the file to be shared and metadata indicative of the file sharing input.

Example 10 is the computer implemented method of any or all previous examples and further comprising:

searching the chat thread for the file index entry;

returning search results indicative of any file index entries identified; and

generating a file index representation indicative of the search results.

Example 11 is the computer implemented method of any or all previous examples and further comprising:

generating a visualization of the file index representation for user interaction.

Example 12 is the computer implemented method of any or all previous examples wherein generating the file index entry comprises:

generating the file index entry so that it is searchable separately from the other messages in the chat thread, sent between the first and second users.

Example 13 is the computer implemented method of any or all previous examples and further comprising:

surfacing the chat thread for user visualization, without surfacing the file index entry in the chat thread, for user visualization.

Example 14 is the computer implemented method of any or all previous examples and further comprising:

modifying file access permissions based on the file sharing input.

Example 15 is the computer implemented method of any or all previous examples and further comprising:

receiving a user file sharing request input indicative of a request to share a file through the communication system.

Example 16 is the computer implemented method of any or all previous examples and further comprising:

aggregating file identifiers indicative of shareable files, based on the file sharing request input; and

generating an aggregate file view with a user actuatable element corresponding to each shareable file, wherein modifying the access permissions comprises modifying file access permissions for a given file, based on user actuation of a user actuatable element.

Example 17 is a computing system, comprising:

a communication system that facilitates a chat communication between a first user and a second user by sending messages between the first user and the second user based on chat user inputs from the first and second users user through a chat user interface, the communication system generating a file sharing input to file sharing logic based on a file sharing user input from the first user through the chat user interface, the file sharing input identifying a file to be shared with the second user through the communication system;

maintenance logic that maintains a chat thread indicative of messages sent between the first and second users in the chat communication;

file index entry generator logic that generates a file index entry in the chat thread, the file index entry identifying the file to be shared and metadata indicative of the file sharing input;

file index searching logic that searches the chat thread for the file index entry and generates a file index representation indicative of any file index entries identified by the search; and

chat file surfacing logic configured to generate a visualization of the file index representation for user interaction.

Example 18 is the computing system of any or all previous examples wherein the file index generator logic is configured to generate the file index entry so that it is searchable separately from other messages in the chat thread, sent between the first and second users, and further comprising:

chat surfacing logic configured to surface the chat thread for user visualization, without surfacing the file index entry in the chat thread for user visualization.

Example 19 is the computing system of any or all previous examples wherein the file sharing logic is configured to modify file access permissions based on the file sharing input.

Example 20 is the computing system of any or all previous examples and further comprising:

user interface logic configured to receive a user file sharing request input indicative of a request to share a file through the communication system;

file aggregation logic that aggregates file identifiers indicative of shareable files, based on the file sharing request input; and

aggregate file viewer logic configured to generate an aggregate file view with a user actuatable element corresponding to each shareable file, the file sharing logic being configured to modify file access permissions for a given file, based on user actuation of a user actuatable element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a communication system that facilitates a chat communication between a first user and a second user by sending messages between the first user and the second user based on chat user inputs from the first and second users user through a chat user interface, the communication system generating a file sharing input to file sharing logic based on a file sharing user input from the first user through the chat user interface, the file sharing input identifying a file to be shared with the second user through the communication system;
maintenance logic that maintains a chat thread indicative of messages sent between the first and second users in the chat communication;
file index entry generator logic that generates a file index entry in the chat thread, the file index entry identifying the file to be shared and metadata indicative of the file sharing input; and
file index searching logic that searches the chat thread for the file index entry and generates a file index representation indicative of any file index entries identified by the search.

2. The computing system of claim 1 and further comprising:
chat file surfacing logic configured to generate a visualization of the file index representation for user interaction.

3. The computing system of claim 2 wherein the file index generator logic is configured to generate the file index entry so that it is searchable separately from other messages in the chat thread, sent between the first and second users.

4. The computing system of claim 3 and further comprising:
chat surfacing logic configured to surface the chat thread for user visualization, without surfacing the file index entry in the chat thread, for user visualization.

5. The computing system of claim 4 wherein the chat file surfacing logic is configured to receive a user search input indicative of a search request, and wherein the file index searching logic is configured to identify any files shared in the chat and to search for any file index entries in the chat thread based on the user search input.

6. The computing system of claim 5 wherein the file sharing logic is configured to modify file access permissions based on the file sharing input.

7. The computing system of claim 6 and further comprising:
user interface logic configured to receive a user file sharing request input indicative of a request to share a file through the communication system.

8. The computing system of claim 7 and further comprising:
file aggregation logic that aggregates file identifiers indicative of shareable files, based on the file sharing request input; and
aggregate file viewer logic configured to generate an aggregate file view with a user actuatable element corresponding to each shareable file, the file sharing logic being configured to modify file access permissions for a given file, based on user actuation of a user actuatable element.

9. A computer implemented method, comprising:
receiving chat user inputs from a first user and a second user through a set of chat user interfaces;
sending messages between the first user and the second user in a chat communication based on the chat user inputs from the first and second users through the chat user interface;
receiving a file sharing user input from the first user through the chat user interface;
generating a file sharing input to file sharing logic based on the file sharing user input from the first user through the chat user interface, the file sharing input identifying a file to be shared with the second user through the communication system;
generating a chat thread indicative of the messages sent between the first and second users in the chat communication; and
generating a file index entry in the chat thread, the file index entry identifying the file to be shared and metadata indicative of the file sharing input.

10. The computer implemented method of claim 9 and further comprising:
searching the chat thread for the file index entry;
returning search results indicative of any file index entries identified; and
generating a file index representation indicative of the search results.

11. The computer implemented method of claim 10 and further comprising:
generating a visualization of the file index representation for user interaction.

12. The computer implemented method of claim 11 wherein generating the file index entry comprises:
generating the file index entry so that it is searchable separately from the other messages in the chat thread, sent between the first and second users.

13. The computer implemented method of claim 12 and further comprising:
surfacing the chat thread for user visualization, without surfacing the file index entry in the chat thread, for user visualization.

14. The computer implemented method of claim 13 and further comprising:
modifying file access permissions based on the file sharing input.

15. The computer implemented method of claim 14 and further comprising:
receiving a user file sharing request input indicative of a request to share a file through the communication system.

16. The computer implemented method of claim 15 and further comprising:
aggregating file identifiers indicative of shareable files, based on the file sharing request input; and
generating an aggregate file view with a user actuatable element corresponding to each shareable file, wherein modifying the access permissions comprises modifying file access permissions for a given file, based on user actuation of a user actuatable element.

17. A computing system, comprising:
a communication system that facilitates a chat communication between a first user and a second user by sending messages between the first user and the second user based on chat user inputs from the first and second users user through a chat user interface, the communication system generating a file sharing input to file sharing logic based on a file sharing user input from the first user through the chat user interface, the file sharing input identifying a file to be shared with the second user through the communication system;
maintenance logic that maintains a chat thread indicative of messages sent between the first and second users in the chat communication;
file index entry generator logic that generates a file index entry in the chat thread, the file index entry identifying the file to be shared and metadata indicative of the file sharing input;
file index searching logic that searches the chat thread for the file index entry and generates a file index representation indicative of any file index entries identified by the search; and
chat file surfacing logic configured to generate a visualization of the file index representation for user interaction.

18. The computing system of claim 17 wherein the file index generator logic is configured to generate the file index entry so that it is searchable separately from other messages in the chat thread, sent between the first and second users, and further comprising:
chat surfacing logic configured to surface the chat thread for user visualization, without surfacing the file index entry in the chat thread for user visualization.

19. The computing system of claim 18 wherein the file sharing logic is configured to modify file access permissions based on the file sharing input.

20. The computing system of claim 19 and further comprising:
user interface logic configured to receive a user file sharing request input indicative of a request to share a file through the communication system;
file aggregation logic that aggregates file identifiers indicative of shareable files, based on the file sharing request input; and
aggregate file viewer logic configured to generate an aggregate file view with a user actuatable element corresponding to each shareable file, the file sharing logic being configured to modify file access permissions for a given file, based on user actuation of a user actuatable element.
